(19) United States
(12) Patent Application Publication
(10) Pub. No.: US 2018/0043267 A1
(43) Pub. Date: Feb. 15, 2018

(54) Ball Reflecting Video Game

(71) Applicant: David De Boer, Big Bear Lake, CA (US)

(72) Inventor: David De Boer, Big Bear Lake, CA (US)

(21) Appl. No.: 15/236,415

(22) Filed: Aug. 13, 2016

(51) Int. Cl. A63F 13/812; A63F 13/60; A63F 13/48; A63F 13/44

(52) U.S. Cl. CPC A63F 13/812; A63F 13/44; A63F 13/60; A63F 13/48

(57) ABSTRACT

A video game to be played in two or three dimensions in which the player must guide a ball to a goal. The ball is continuously moving and the player must place reflectors to guide the ball to the goal without letting it get destroyed. The player places reflectors by choosing a point in the game space and letting it grow larger and larger from that point. The amount of time a reflector grows is determined by the length of time the player's input is active. If the player leaves the input active for too long the reflector will destroy itself after reaching its maximum size. A player is successful if they guide the ball to the goal but if the ball hits anything other than a reflector or the goal then ball is destroyed and the player fails.

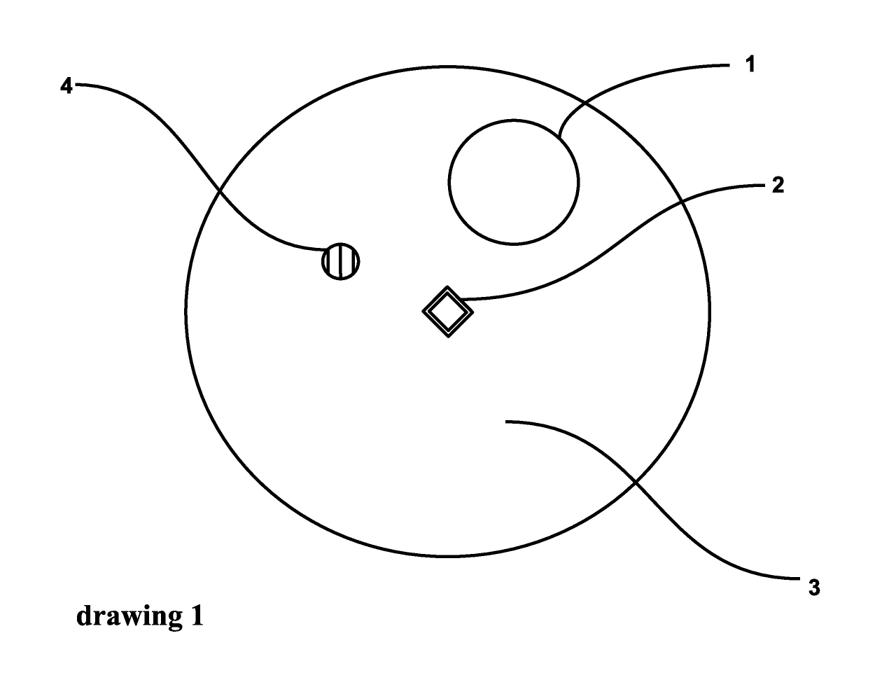

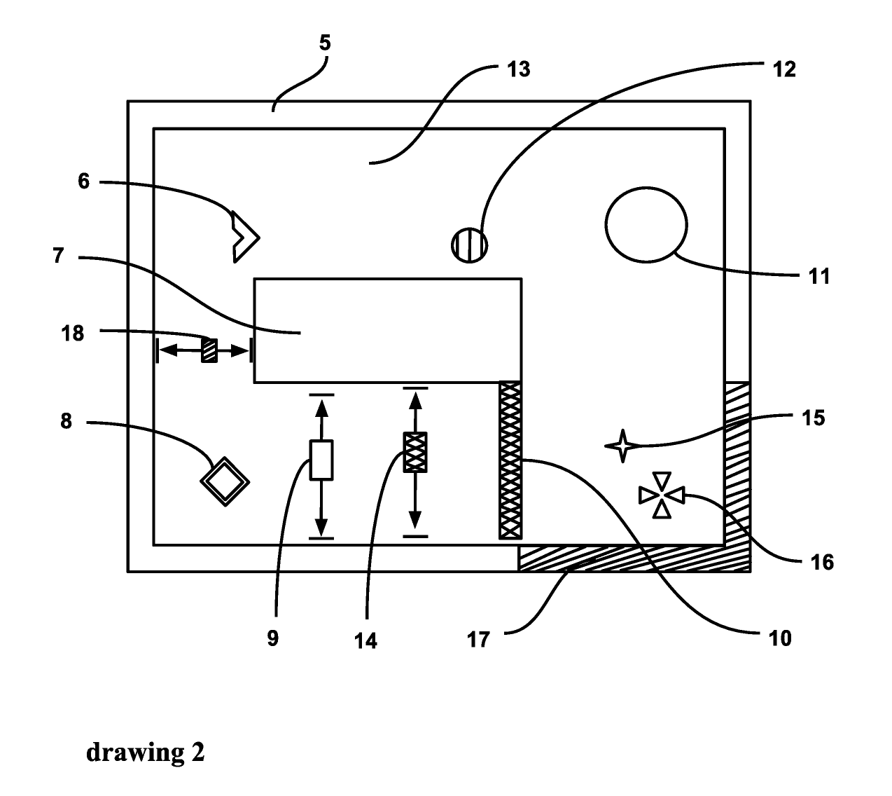

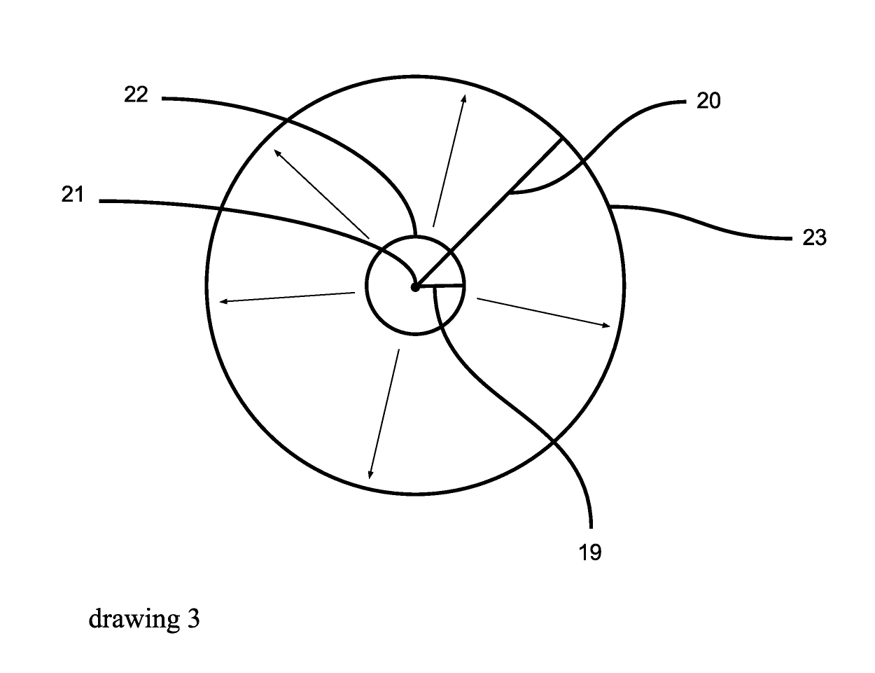

### BACKGROUND OF INVENTION

The current state of video games includes 2d and 3d gaming. The state of video game input methods includes: touchscreen/touchpad (2d input), gamepads (2d and 3d input), specialized 3d input for virtual reality and augmented reality. The available inputs for video games provide for numerous systems for players to quickly and accurately select points in 2d spaces and 3d spaces. The current invention leverages this ability to select points in 2d and 3d to create a new and unique game to test the player's skill. Video games are often organized in levels. Levels serve to introduce new concepts into a games gameplay. The first levels often utilizes minimal core components required to play the game. As the player progresses through levels, new elements are brought into the game to add depth and further test the player's skill. By the final level all game elements have been introduced and utilized to test the player's skill.

### SUMMARY: (USUALLY ONE PARAGRAPH DESCRIPTION OF THE INVENTION)

The invention is a video game to be played in two dimensions or three dimensions. The goal of the video game is to navigate a continually moving “ball” (a circle in 2d and a sphere in 3d) from its “starting point” to the “goal”. Once the ball is moving in a direction it continues in that direction until the “player” places a “reflector” (a circle in 2d and a sphere in 3d) in the ball's path. When the ball and the reflector collide the ball will reflect off the reflector and change its direction. To place a reflector, the player must choose a point to “grow” the reflector at within the “game space”. The reflector starts at its minimum size at the point the player selects using the “input method” when he activates his “Input”, and then immediately starts to grow (increasing in radius) as long as the player keeps the input active. The player can stop the growth of the reflector by deactivating the input, but if the input is left active for too long (or radius gets too large) the reflector will be destroyed and cease to exist. Both the size and the location of the reflector will affect the ball's trajectory. Only one reflector can be placed at a time, and when the player places a second reflector the first reflector will be destroyed and cease to exist. When the ball touches the goal then a “score” is recorded. If the game ball touches a “boundary” then the ball is destroyed and a “fault” is recorded.

### DESCRIPTION OF DRAWINGS

Drawing 1 is a 2d representation of the game and minimal game components.

Drawing 2 is a 2d representation of the game with full components.

Drawing 3 is a 2d representation of the reflector growing.

### DETAILED DESCRIPTION OF HOW THE INVENTION WORKS

The invention is a new video game where the underlying mechanics rely on game object collision detection and the physics of ball collisions.

Drawing 1 is an illustration of an example 2d circular shaped game area with minimal components. In Drawing 1 we see a game space, designated by the number 3, with a ball object 4, a reflector object 1, and a goal object 2. Drawing 1 lacks a starting point object, because the invention in the simplest form can utilize a random starting point and launch direction, or utilize the goal 2 point as the starting point and randomise only the launch direction. The game is started by launching the ball 4. It is then up to the player to place reflectors 1 within the game space 3 to guide the ball 4 to the goal 2. The player places a reflector 1 by selecting a point in the game space 3. Drawing 1 assumes the player has access to directly input into the game space 3 (i.e. touchscreen for 2d input). If the player does not have a direct access to input into the game space than a cursor 16, as depicted in Drawing 2, is needed to select points in the game space 3. Once a point is selected by the player the reflector 1 is placed into the game world at its minimum size and a timer is started. As the player holds the input active the radius of the reflector 1, 11 grows as a nondecreasing function of the timer, as seen in Drawing 3. Drawing 3 shows the player input point 21, the initial radius 19, the initial edge 21, the maximum radius 20 and the ending edge of the reflector 1, 11 The arrows in Drawing 3 depict the growth of the reflector 1, 11 over the time the input is held active by the player. A reflector is destroyed when a ball reflects off of it, or when the player leaves the input active for too long such that either the timer or the radius surpasses its respective prespecified maximum value, or if the player places a new reflector 1 into the game space 3. When the ball 4 collides with the reflector 1, then the ball 4 will change its path direction based on a physics based reflection between the ball 4 and the reflector 1. The ball 4 is destroyed when it collides with the goal 2 resulting in a score and the ball 4 is also destroyed if it leaves the game space 3 resulting in a fault.

Drawing 2 is an illustration of an example 2d game area with full game components. In Drawing 2 we see a game space 13 surrounded by a boundary 5 and safe-boundary 17. There is also a boundary 7 within the game space 13. Drawing 2 also depicts a starting point 6, a reflector 11, the ball 12, the goal 8, a moving boundary 9, destroyable-safe-boundary 10, a input cursor 16, a moving safe-boundary 18, a moving destroyable-safe-boundary 14, and a collectable-object 15. When the ball 12 collides with a boundary 5, 7 or a moving boundary 9 then the ball 12 is destroyed resulting in a fault. When the ball 12 collides with a safe-boundary 17, 18, 10, 14 then the ball 12 is reflected off the safe-boundary 17, 18, 10, 14. A safe-boundary can also be destroyable. If a safe-boundary is a destroyable-safe-boundary 10, 14 then the destroyable-safe-boundary 10, 14 will be destroyed directly after reflecting the ball 12. The starting point 6 gives the point and direction to launch the ball 12. Collectable-objects 15 are collected by the player when the ball 12 collides with them. Collectable-objects 15 are destroyed when the ball 12 collides with them and do not alter the ball's 12 path. Only the ball 12 and the reflector 11 have predefined shapes, circular for 2d implementation and Spherical for 3d implementation, all other objects are free to take on other geometries.

The 3d implementation of the game is a simple mapping from 2d into 3d and conserving the same gameplay by letting the ball 4,12 and reflector 1, 11 become spheres rather than circles and by letting the game space 3,13 become a volume as opposed to an area. All other objects are still free to take on any geometry.

The objective of the game is for the player to guide the ball 4, 12 to the goal 2, 8 by means of placing reflectors 1, 11 in the ball's path to direct the ball 4, 12 towards the goal 2, 8 without having a fault. A fault requires the player to start over by re-launching the ball 4, 12. The game allows for many levels to be designed from the components. Guiding the ball 4, 12 from its starting point 6 to the goal 2, 8 successfully clears a level.

A multiplayer variation can easily be implemented by allowing any number of players to take turns placing the reflector 1, 11. For scoring purposes the player that placed the last reflector 1, 11 touched by the ball 4, 12 before the ball touched the goal 2, 8 is credited with the score.

1. A video game consisting of:
a game space;
a ball;
a starting point;
an input method; and
a reflector such that said reflector is a ball in shape and is placed into the game space by player input; said reflector grows in radius as a nondecreasing function of time while the player keeps the input active; said reflector is destroyed when any of the following conditions are met: i) the ball reflects off said reflector, ii) the amount of time the input is active from placement is longer than a prespecified time constraint, iii) the radius becomes larger than a prespecified maximum radius, iv) the player chooses a new point in the game space to place said reflector; and
a goal;
such that the starting point is contained within the game space and dictates where the ball is launched from; the input method is utilized by the player to place the reflector within the game space; the objective of the game is to guide the ball from the starting point to the goal, also contained within the game space, by the player placing the reflector in the ball's path without letting the ball get destroyed; the ball is destroyed when it is not in the game space.

2. The invention in claim 1 with the addition of one or more boundaries, such that if the ball touches said boundary then the ball will be destroyed.

3. The invention in claim 1 with the addition of one or more safe-boundaries, such that if the ball touches said safe-boundaries then the ball will be reflected.

4. The invention in claim 1 with the addition of one or more destroyable-safe-boundaries, such that if the ball touches said destroyable-safe-boundaries then the ball will be reflected and the destroyable-safe-boundaries will be destroyed.

5. The invention in claim 1 with the addition of one or more collectable-objects, such that if the ball touches said collectable-objects then said collectable-objects will be destroyed.

6. The invention in claim 1 with the addition of one or more boundaries, such that if the ball touches said boundary then the ball will be destroyed, and one or more safe-boundaries, such that if the ball touches said safe-boundaries then the ball will be reflected.

7. The invention in claim 1 with the addition of one or more boundaries, such that if the ball touches said boundary then the ball will be destroyed, and one or more destroyable-safe-boundaries, such that if the ball touches said destroyable-safe-boundaries then the ball will be reflected and the destroyable-safe-boundaries will be destroyed.

8. The invention in claim 1 with the addition of one or more boundaries, such that if the ball touches said boundary then the ball will be destroyed, and one or more collectable-objects, such that if the ball touches said collectable-objects then said collectable-objects will be destroyed

9. The invention in claim 1 with the addition of one or more safe-boundaries, such that if the ball touches said safe-boundaries then the ball will be reflected, and one or more destroyable-safe-boundaries, such that if the ball touches said destroyable-safe-boundaries then the ball will be reflected and the destroyable-safe-boundaries will be destroyed.

10. The invention in claim 1 with the addition of one or more safe-boundaries, such that if the ball touches said safe-boundaries then the ball will be reflected, and one or more collectable-objects, such that if the ball touches said collectable-objects then said collectable-objects will be destroyed.

11. The invention in claim 1 with the addition of one or more destroyable-safe-boundaries, such that if the ball touches said destroyable-safe-boundaries then the ball will be reflected and the destroyable-safe-boundaries will be destroyed, and one or more collectable-objects, such that if the ball touches said collectable-objects then said collectable-objects will be destroyed.

12. The invention in claim 1 with the addition of one or more boundaries, such that if the ball touches said boundary then the ball will be destroyed, and one or more safe-boundaries, such that if the ball touches said safe-boundaries then the ball will be reflected, and one or more destroyable-safe-boundaries, such that if the ball touches said destroyable-safe-boundaries then the ball will be reflected and the destroyable-safe-boundaries will be destroyed.

13. The invention in claim 1 with the addition of one or more boundaries, such that if the ball touches said boundary then the ball will be destroyed, and one or more safe-boundaries, such that if the ball touches said safe-boundaries then the ball will be reflected, and one or more collectable-objects, such that if the ball touches said collectable-objects then said collectable-objects will be destroyed.

14. The invention in claim 1 with the addition of one or more boundaries, such that if the ball touches said boundary then the ball will be destroyed, and one or more destroyable-safe-boundaries, such that if the ball touches said destroyable-safe-boundaries then the ball will be reflected and the destroyable-safe-boundaries will be destroyed, and one or more collectable-objects, such that if the ball touches said collectable-objects then said collectable-objects will be destroyed.

15. The invention in claim 1 with the addition of one or more safe-boundaries, such that if the ball touches said safe-boundaries then the ball will be reflected, and one or more destroyable-safe-boundaries, such that if the ball touches said destroyable-safe-boundaries then the ball will be reflected and the destroyable-safe-boundaries will be destroyed, and one or more collectable-objects, such that if the ball touches said collectable-objects then said collectable-objects will be destroyed.

16. The invention in claim 1 with the addition of one or more boundaries, such that if the ball touches said boundary then the ball will be destroyed, and one or more safe-boundaries, such that if the ball touches said safe-boundaries then the ball will be reflected, and one or more destroyable-safe-boundaries, such that if the ball touches said destroyable-safe-boundaries then the ball will be reflected and the destroyable-safe-boundaries will be destroyed, and one or more collectable-objects, such that if the ball touches said collectable-objects then said collectable-objects will be destroyed.

17. The invention in claim 1 modified to allow the player to place n reflectors simultaneously, where n is an integer greater than 1, and a reflector's property of being destroyed by the placement of a new reflector is modified to only being destroyed by a new reflector placement if it is the oldest reflector and the new reflector will result in n+1 reflectors.

18. The invention in claim 1 modified such that the reflector's growth behavior is changed such that the reflector starts at the maximum radius and shrinks in radius as a nonincreasing function of time while the player keeps the input active, and the reflectors destruction behavior is modified such that if the radius becomes smaller than a prespecified minimum radius the reflector will be destroyed in lieu of destroying on if the radius becomes larger than a prespecified maximum radius.

19. The invention in claim 18 modified to allow the player to place n reflectors simultaneously, where n is an integer greater than 1, and a reflector's property of being destroyed by the placement of a new reflector is modified to only being destroyed by a new reflector placement if it is the oldest reflector and the new reflector will result in n+1 reflectors.
